(19) United States
(12) Patent Application Publication
(10) Pub. No.: US 2001/0053138 A1
(43) Pub. Date: Dec. 20, 2001

(54) ATM handoff process

(76) Inventors: Radhakrishna Pillai Raghavan Pillai, Singapore (SG); Maitreya Ranganath, Singapore (SG); Rahul Agrawal, Sunny Vale, CA (US)

Correspondence Address: SENNIGER POWERS LEAVITT AND ROEDEL, ONE METROPOLITAN SQUARE, 16TH FLOOR, ST LOUIS, MO, 63102, US

(21) Appl. No.: 09/800,132

(22) Filed: Mar. 6, 2001

(30) Foreign Application Priority Data
Mar. 9, 2000 (SG) SG200001264-1

(51) Int. Cl. H04L 12/56; H04Q 7/00

(52) U.S. Cl. 370/331; 370/409; 455/436; 370/395.1

(57) ABSTRACT

A method of handoff of a virtual channel connection of a mobile terminal in a wireless ATM networks under the control of a connection manager is disclosed comprising the steps of:

transmitting a sequence of handoff messages between the mobile terminal and the connection manager;

executing a sequence of operations by the connection manager for re-routing the virtual connections; and wherein the re-routing of a downstream connection is scheduled using a timer.

### BACKGROUND AND FIELD OF THE INVENTION

This invention relates to handoff in wireless Asynchronous Transmission Mode (ATM) networks.

A wireless ATM network is illustrated in FIG. 1 and comprises mobile or wireless terminals MT1-MT4, access points AP1-AP3, ATM switches ATM1, ATM2, EMAS1 and EMAS2 and fixed terminals FT1, FT2. The mobile terminals (MT) are linked to the access points (AP) through radio links with the radio cell of the access points AP being shown by the circle surrounding the access point. ATM switches having mobility management capabilities are shown designated EMAS, (an End-user Mobility supporting ATM Switch). All other ATM switches are designated ATM. The access points AP are connected to the ATM network through wired links. Each AP comprises of a single port transceiver serving a group of portable mobile ATM terminals within its radio cell. Fixed terminals FT and access points AP could either be connected to an ATM switch or to an EMAS using wired links.

A wireless ATM network offers connection-oriented services. Terminals establish virtual connections with other terminals for communication under control of a connection manager CM and release these connections after use. The user data is carried over these connections as fixed sized packets known as ATM cells. When the terminal is moving from one radio cell to another, in order to ensure continuity of communication on the established connection, a procedure called handoff takes place and the connection is re-routed through the access point corresponding to the new radio cell.

To minimise the interruption to the communication, it is desirable that there is call continuity during handoff. However, this is not always possible and it is an object of the invention to provide a handoff method which addresses this difficulty.

### SUMMARY OF THE INVENTION

According to the invention, there is provided a_method of handoff of a virtual channel connection of a mobile terminal in a wireless ATM networks under the control of a connection manager comprising the steps of transmitting a sequence of handoff messages between the mobile terminal and the connection manager; executing a sequence of operations by the connection manager for re-routing the virtual connection; and wherein the re-routing of a downstream connection is scheduled using a timer.

### BRIEF DESCRIPTION OF THE DRAWINGS

An embodiment of the invention will now be described, by way of example, with reference to the accompanying drawings in which:

FIG. 1 illustrates a wireless ATM network to which the embodiment of the present invention is applied;

FIG. 2 illustrates connection re-routing in the network of FIG. 1;

FIG. 3 shows the timing of backward handoff using an embodiment of the method of the present invention; and

FIG. 4 shows cell loss/duplication as a function of the relative make segment setup time.

### DETAILED DESCRIPTION OF THE PREFERRED EMBODIMENT

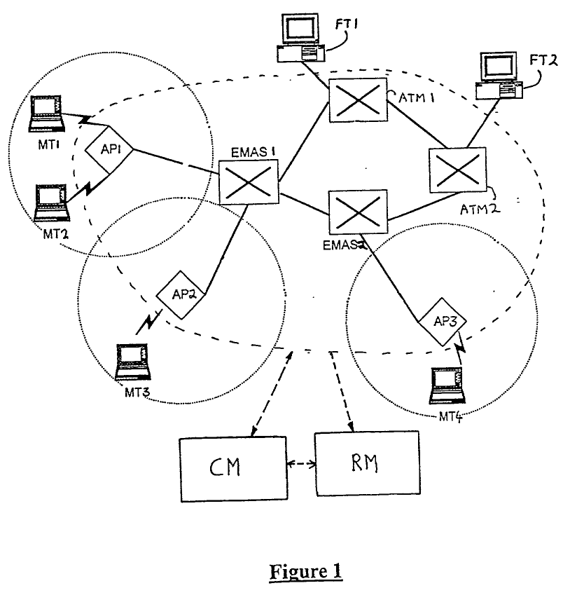

The embodiment of the present invention concerns a method of performing handoff in a wireless ATM network of the kind illustrated in FIG. 1 and described above.

In the described embodiment, in order to decide when handoff should take place, each mobile terminal keeps measuring the radio signal strength from access points within range and other parameters. Like connection set up or release, handoff involves signalling between the terminals and the network. Handoff may be backward or forward. In backward handoff, the terminal initiates the handoff signalling with the network through the current access point. In forward handoff, the mobile terminal initiates the signalling through the new access point. As will be apparent to one skilled in the art, the connection management and re-routing is carried out by a logical entity in the network called a connection manager CM. The terminal makes use of the connection manager services through signalling. To provide these services, the connection manager CM manages the network resources such as bandwidth, namespace and so on. In a distributed environment like CORBA, the connection manager CM can be considered as an object providing open interfaces for different connection management services.

To realise the network services provided by the connection manager CM, the network resources need to be manipulated. This necessitates the access to network resources by the connection manager CM. For example, to set up an end-to-end connection between two terminals, the connection manager CM needs to set up connections across every switching node involved along the path including access points, if any and allocate the switch and access point resources required for the connection. The network nodes have interfaces for this purpose. The Binding Interface Base defined for programmable networks in the IEEE P1520 working group is an example [4, 5, 7, 11].

To decide the route along which a connection needs to be set up, the connection manager CM makes use of the service of another server called a route manager RM which provides the optimal route between two terminals based the current points of attachment of the terminals. The route manager RM keeps track of the location of terminals as they may change location in a mobile network. The route information is returned as a set {a₁, a₂. . . a₁} consisting of the network nodes involved in the connection.

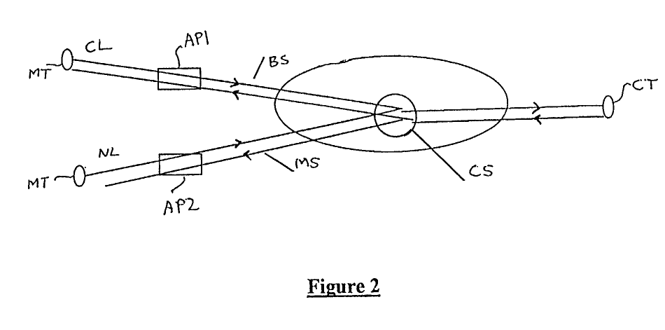

During handoff as illustrated in FIG. 2, a crossover switch CS is first determined based on the current location CL and new location NL of the mobile terminal MT. The crossover switch CS is the switch up to which the connections from the corresponding (connected) terminal CT to the new and old locations of the mobile terminal MT are common. The connection from the crossover switch to the mobile terminal MT is what is re-routed. The part of the connection from the crossover switch CS to the mobile terminal MT at the new location NL is called a make segment MS (via access point AP2) and that from the crossover switch to the old location is called a break segment BS (via access point AP1). The connection re-routing involves setting up the connection along the make segment MS followed by deleting the connection along the break segment BS.

The various operations involved in connection re-routing during handoff are the following:

Set up the make segments of the downstream connections

Delete the break segments of the downstream connections

Delete the break segments of the upstream connections

Set up the make segments of the upstream connections

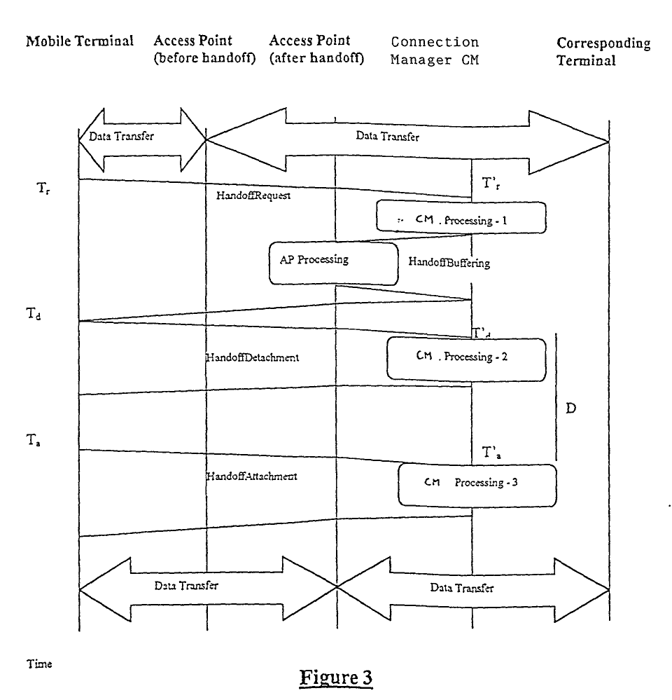

The signalling involved in backward handoff is shown in FIG. 3. The messages are processed either by the access points AP or connection manager CM or both and a response is sent back. Only the successful cases of the signalling are shown. In backward handoff, the mobile terminal initiates the handoff signalling with the current access point whereas in forward handoff, the mobile terminal initiates handoff signalling with the new access point. In backward handoff, the handoff detachment (from the current access point) and the handoff attachment (to the new access point) follow the handoff request. The access point relays the handoff signalling messages between the mobile terminal and the connection manager CM. There are various approaches for re-routing the connections during hand-off as will be apparent to one skilled in the art such as virtual channel extension, anchor-based re-routing, dynamic crossover switch based re-routing and so on and the approach used is essentially a tradeoff between network resource usage and performance.

The virtual connections (VCs) from the mobile terminal to the network consists of upstream (used by the mobile terminal for transmission) as well as downstream (used by mobile terminal for reception) connections. The data on these connections are called upstream and downstream data respectively. The backward handoff used in this example takes place from access point AP1 to access point AP2.

At time Tᵣ, the mobile terminal sends out a HandoffRequest message to connection manager CM through access point 1 (AP1). Connection manager CM then decides the access point to which handoff should take place and instructs this access point AP2 to start buffering the downstream data, and then responds to the HandoffRequest message. The mobile terminal then sends a HandoffDetachment message at time T_{d} through access point AP1 and the connection manager CM responds to this. After successful detachment from access point AP1, the terminal sends out a HandoffAttachment message through access point AP2 and connection manager CM responds to it. Once the attachment is successful, the data transfer between the terminal and the network takes place through AP2. The three messages HandoffRequest, HandoffDetachment, and HandoffAttachment and their response or confirmation from the connection manager CM pass through the respective access points and hence the access points are aware of these events. The connection manager CM is aware of all connections that are active at the mobile terminal. The details of the connection manager CM's actions (CM processing 1-3 in FIG. 3) in response to the messages are explained below:

### CM Processing -1

Decide or select the access point (new AP) to which handoff should take place

For every connection originating or terminating at the mobile terminal MT,

Invoke the Route Manager and obtain the optimal route between the corresponding terminal CT and the new access point. Compute the crossover switch and the make and break segments

Assign connection identifiers (i.e., vpi/vci values) for individual links on the make segment

Insert the details into the connection database in connection manager CM

Instruct the new access point AP to start buffering of downstream data

Confirm the HandoffRequest from the mobile terminal MT.

### CM Processing -2

Update the location of the mobile terminal at the Route Manager

Schedule the set up of make segments of downstream connections using a timer

Schedule the deletion of break segments of downstream connections using a timer

Delete the break segments of the upstream connections

Set up the make segments of the upstream connections

### CM Processing -3

Authenticate the terminal

Update the location of the mobile terminal at the Route Manager

Allocate wireless resources at AP2

The processing at the access point AP2 (AP processing of FIG. 3) is as follows:

Allocate radio resources for the mobile terminal

Allocate memory for buffering the downstream data

A feature of the described embodiment is that the time at which the connections are re-routed is controlled using a timer. As mentioned above, the re-routing consists of two major operation for each virtual connection that is active: (i) setting up the connection along the make segment (ii) releasing the connection along the break segment.

The mobile terminal MT will be sending application data through access point AP1 until it sends out the HandoffDetachment message at time T_{d}. The upstream data in transit will go through the virtual connection before the break segment of this connection is deleted by connection manager CM (connection manager CM processing-2). From time T_{d} onwards, the upstream data is stored in the mobile terminal MT, until the attachment to AP2 is completed. The earliest time at which the make segment of the downstream connection will be set up is T′_{d}. The mobile terminal MT will be receiving application data until the terminal receives the response to its HandoffDetachment message. The downstream data during that period may also be buffered at AP2, depending on the time at which its make segment is set up. Once the MT gets attached to AP2, the upstream as well as downstream data transmissions resume.

Though AP2 is instructed to start buffering the data after receiving the HandoffRequest message by connection manager CM, the actual number of ATM cells buffered at AP2 depends on the time elapsed from the instant at which the make segment of the downstream connection is set up till the time at which the attachment to AP2 takes place.

The following sequence of operations occurs during handoff:

1. Set up the make segment of a downstream connection after StartBuffering instruction is given to AP2 to make sure that buffers have been allocated

2. Carryout the deletion of the break segment and set up of the make segment of a downstream connection after receiving the HandoffDetachment message from the mobile terminal.

3. Delete the break segment of an upstream connection before setting up the make segment of the upstream connection, to avoid virtual connection merging.

Since, the re-routing of an upstream connection is well controlled, neither cell loss nor cell duplication occurs in this connection. However, the probability of cell loss or duplication in a downstream connection is high depending on the time at which the make segment is set up.

After receiving the HandoffDetachment message, the break segment of a downstream connection is deleted at time T=T′_{d}+t. The value of t is chosen in such a way that the downstream data in transit will be completely received by the MT before receiving the response to its HandoffDetachment message.

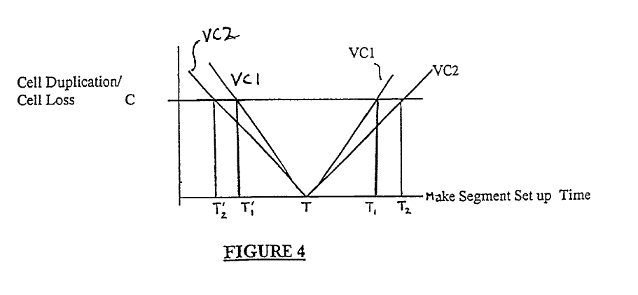

As shown in FIG. 4, if the make segment of the downstream connection is set up before deleting the break segment of the downstream connection, then cell duplication occurs and if it is done after deleting its break segment, cell loss occurs. When set up and deletion both occur at time T, this results in zero cell loss and zero cell duplication. The amount of cell loss/duplication depends on the set up time as well as the bandwidth and other QoS parameters associated with the virtual connection. For example, the behaviour of two virtual connections, VC1 and VC2, having different bandwidths is shown in the FIG. 4 (VC1 is having higher bandwidth compared to VC2). If the application using a virtual connection needs strictly zero cell loss, the set up should happen at time T. If the application can tolerate cell loss up to level C, then the set up can be done by time T₁ for VC1 and time T₂ for VC2. On the other hand, if the application cannot tolerate cell duplication above level C, then the set up has to be done only after time T′₁ for VC1 and time T′₂ for VC2. The set up is thus controlled using a timer with a timeout value depending on the QoS and other parameters. This way, the described embodiment can minimize the buffer requirements at AP2, by exploiting the application requirements.

Using the timer based mechanism, the make segments of different virtual connections can be set up at different times depending on the requirements of the applications. This way, the buffering at access point AP2 can be optimised. Once the connection manager CM receives the HandoffDetachment message, a timer is started with a time out value x. The make segment set up takes place when the timer expires. The timeout value can be decided based on the application requirements. For example, if the application using the virtual connection can neither tolerate cell loss nor cell duplication, then the time out value should be exactly equal to t, in order to coincide with the deletion of the break segment. On the other hand, if an application cannot tolerate any cell loss but can tolerate some amount of cell duplication, then the timeout value should be less than t. If the application is able to tolerate cell loss, the set up can be scheduled for a time after t, depending on the amount of cell loss the application can tolerate.

In general, the timeout value will be x=min(d,D) where D is the time elapsed between receiving the HandoffDetachment message and the HandoffAttachment message (see FIG. 3), d is the time out value decided based on the application characteristics which can be found out by experimentation. When there are multiple number of virtual connections, each can use an appropriate value of d. In this case, the make segment set up occurs by time D. This need not be the case always and one may use other values as well. If the connection set up procedure experiences a delay of s, then the timeout value should be x-s. The value of d can be determined based on the application characteristics, and the quality of service guaranteed for the virtual connection. This information can be conveyed to the connection manager CM in the HandoffRequest message so that the timer can be programmed in advance.

If there are N nodes (i.e. switches and access points) involved in the make segment, to have a more precise control over the set up time, the connection at the cross-over switch can be set up at the timer controlled instant and the connections at the remaining (N−1) nodes can be set up in advance immediately after receiving the HandoffDetachment message. In this case, the ATM cell data flow on the make segment will take place only after the connection at the crossover switch CS has been set up.

In practice, the mobile terminal will continue to receive downstream data for a short period even after receiving the response to its HandoffDetachment message. This can continue until the mobile terminal switches the Radio frequency (RF) carrier from AP1 to AP2. The described embodiment can exploit this fact in scheduling the virtual connection re-routing. As a result, the deletion of the break segment and the set up of the make segment can be delayed further, based on an estimate of the time taken by the mobile terminal to switch the RF carrier. As a result, the buffering at AP2 can be further reduced.

Although the embodiment described uses backward handoff, the invention is equally applicable to rerouting connections using forward handoff as will be apparent to one skilled in the art upon reading this specification.

Although the embodiment described has illustrated the technique of the present invention applied to virtual channel connections to/from a mobile terminal, the technique is equally applicable to rerouting virtual path connections to/from the mobile terminal.

The following references and patents are background reading for the skilled man, although not strictly necessary for the understanding of the invention and are incorporated herein by reference:

### References

1. R. R. Pillai, W. Wang, L.-K. Seng, B. Jose, He sha, R. Agrawal, and M. Ranganath, “Implementation and Performance Evaluation of an Open Control Architecture for Wireless ATM Networks,” Proceedings of 1999 IEEE Second conference on Open Architectures and Network Programming (Openarch '99), Mar. 26-27, 1999, New York, pp. 45-58.

2. Mobiware (http://comet.ctr.columbia.edu/mobiware)

3. Biswas et al., “The IEEE P1520 Standards Initiative for Programmable Network Interfaces” IEEE Communications Magazine, October 1998, pp. 64-70 (also see http:l/www.ieee-pin.org)

4. IEEE Draft Technology Submission Working Document IEEE/WG P1520;

Programming Interfaces For Networks—ATM switch Service Interface, IEEE/WG P1520/TS/ATM-018, New York, Mar. 28-29, 1999.

5. IEEE Draft Technology Submission Working Document IEEE/WG P1520;

Programming Interfaces For Networks—Proposal for Standardising the qGSMP protocol, IEEE/WG P1520/TS/ATM/002R1 Princeton, Jan. 18-19, 1999

6. ATM Forum UNI Specifications, Ver 3.1

7. IEEE Draft Technology Submission Working Document IEEE/WG P1520;

Programming Interfaces For Networks—Proposal for standardization of ATM Binding Interface Base for Wireless Access, IEEE/WG P1520/TS/ATM011, New York, Mar. 28-29, 1999.

8. IEEE Draft Technology Submission Working Document IEEE/WG P1520;

Programming Interfaces For Networks—Proposal for standardization of U-Interface Objects for ATM, IEEE/WG P1520/TS/ATM-012, New York, Mar. 28-29, 1999.

9. IEEE Draft Technology Submission Working Document IEEE/WG P1520;

Programming Interfaces For Networks—ATM switch Resource Abstractions, IEEE/WG P1520/TS/ATM-017, New York, Mar. 28-29, 1999.

10. M. Henning and S. Vinoski, “Advanced CORBA Programming with C++”, Addison-Wesley Professional Computing Series.

11. L-H. Ngoh, Hongyi Li, and W. Wang, “An Integrated Multicast Connection Management Solution for Wired and Wireless ATM Networks,” IEEE Communications Magazine, Vol. 35, No. 11, Nov. 1997, pp. 52-59.

### Patents

U.S. Pat. No. 5,838,921 Distributed connection management system with replication PCT/GB97/02802 Switching Systems

U.S. Pat. No. 5,867,498 Intelligent telecommunications network

U.S. Pat. No. 5,802,058 Network-independent connection management

U.S. Pat. No. 5,825,780 method, system and apparatus for telecommunications control

U.S. Pat. No. 5,873,035 Conducting handoff of a data transmission

U.S. Pat. No. 5,802,465 Data transmission in a radio telephone network

U.S. Pat. No. 5,826,030 Telecommunication switch having a universal API with a single call processing message including user-definable data and response message each having a generic format

U.S. Pat. No. 5,825,772 Distributed connection-oriented services for communication networks

U.S. Pat. No. 5,291,544 Method of transferring, between two switching exchanges for mobile services, the handling of an active connection with a mobile terminal

U.S. Pat. No. 5,805,072 VC connection method

U.S. Pat. No. 5,907,542 Dynamic assignment of signalling virtual channels for wireless ATM

U.S. Pat. No. 5,896,373 Method for executing handover in a radio extension of an ATM network

U.S. Pat. No. 5,872,786 ATM communication system, process migration method in the ATM communication system, and handover processing method

U.S. Pat. No. 5,497,504 System and method for connection control in mobile communications

1. A method of handoff of a virtual channel or path connection of a mobile terminal in a wireless ATM networks under the control of a connection manager comprising the steps of:
transmitting a sequence of handoff messages between the mobile terminal and the connection manager;
executing a sequence of operations by the connection manager for re-routing the virtual connection; and wherein the re-routing of a downstream connection is scheduled using a timer.

2. A method as claimed in claim 1 wherein the re-routing comprises the steps of establishing a make segment and deleting a break segment and the timer schedules the make segment to be established before, after or at the same time as the break segment is deleted.

3. A method as claimed in claim 2 wherein the timer schedules the make segment to be established before the break segment is deleted if an application using the virtual connection can tolerate data duplication.

4. A method as claimed in claim 2 wherein the timer schedules make segment to be established after the break segment is deleted if an application using the virtual connection can tolerate data loss.

5. A method as claimed in claim 2 wherein the timer based re-routing occurs from the point at which the make and break segments meet.

6. A method as claimed in claim 1 wherein the timer schedules the re-routing in dependence upon application requirements and quality of service of the connection.

7. A method as claimed in claim 1 wherein the timer schedule for re-routing is estimated based on the time taken for switching of the route.

8. A method as claimed in claim 7 wherein the estimate of time taken includes the time taken for the mobile terminal to switch an RF carrier following re-routing.

9. A method as claimed in claim 1 wherein the transmitting step includes:
(a) the mobile terminal sends a handoff request message to the connection manager via a first access point, indicating the quality of service of the connections and the list of access points to which the connections could be handed off;
(b) the connection manager selects one of the access points as a new access point;
(c) the connection manager obtains an optimal route to the new access point from a route manager and computes a crossover switch, make segment, and break segment for all upstream and downstream connections;
(d) the connection manager instructs the new access point to start buffering the data on the downstream connection;
(e) the connection manager confirms the backward handoff with the mobile terminal, indicating the new access point;
(f) the mobile terminal sends a handoff detachment message to the connection manager, via the first access point;
(g) the connection manager allocates the network resources at the switching nodes and access points along the make segment and sets up the connection, for the downstream connection;
(h) the connection manager de-allocates the network resources at the switching nodes and access points along the break segment and deletes the connection, for the downstream connections;
(i) the connection manager allocates the network resources at the switching nodes and access points along the make segment and sets up the connection, for the upstream connections;
(j) the connection manager de-allocates the network resources at the switching nodes and access points along the break segment and deletes the connection, for the upstream connections;
(k) the connection manager confirms the handoff detachment with the mobile terminal;
(l) the mobile user terminal sends a handoff attachment message to the connection manager, via the new access point;
(m) the connection manager updates the location of the mobile user terminal with the route manager;
(n) the connection manager instructs the new access point to start transferring the buffered data to the mobile terminal; and
(o) the connection manager confirms the handoff attachment with the mobile terminal.

10. A method as claimed in claim 9 the connection manager uses the timer to trigger the allocation of the network resources at the switching nodes and access points along the make segment and setting up the connection, for the downstream connections

11. A method as claimed in claim 10 wherein the time out value of the timer is chosen based on the time of disconnecting the break segment, the cell loss requirement of the application and the time elapsed between receiving the hand off detachment message and the handoff attachment message.

12. A method as claimed in claim 9 wherein the connection manager uses the timer to trigger the allocation of network resources at the switching nodes and access points along the break segment and delete the connection for the downstream connections.

13. A method as claimed in claim 9 wherein the connection manager uses the timer to trigger the allocation of the network resources and connection setup of the make segment only at the crossover switch, the allocation and connection setup at all other nodes of the make segment being effected immediately after receiving the hand off detachment message.
